(19) United States
(12) Patent Application Publication
(10) Pub. No.: US 2026/0038973 A1
(43) Pub. Date: Feb. 5, 2026

(54) BATTERY CELL WITH SPACING ELEMENT

(71) Applicant: NORTHVOLT AB, Stockholm (SE)

(72) Inventor: Rafael Acosta, Västerås (SE)

(21) Appl. No.: 19/103,341

(22) PCT Filed: Aug. 10, 2023
(86) PCT No.: PCT/EP2023/072221

§ 371 Date: Feb. 12, 2025

(30) Foreign Application Priority Data
Aug. 12, 2022 (SE) 2250960-8

(51) Int. Cl. H01M 50/477; H01M 50/15; H01M 50/367; H01M 50/474; H01M 50/531

(52) U.S. Cl. CPC H01M 50/477; H01M 50/15; H01M 50/367; H01M 50/474; H01M 50/531; H01M 2200/20

(57) ABSTRACT

There is disclosed herein a battery cell (100), comprising an electrode assembly (106), a vent (105) in a casing (102) of the battery cell (100), and a spacing element (300) extending along a first side of the electrode assembly (300). The spacing element (300) is arranged in a fluid path between the electrode assembly (106) and the vent (105), and configured to guide gas flow along the fluid path from the electrode assembly (106) to the vent (105).

### TECHNICAL FIELD

The present disclosure relates to components for battery cells. In particular, the present disclosure relates to an improved spacing element for a battery cell and a method for manufacturing a battery cell comprising such an improved spacing element.

### BACKGROUND

In addressing climate change, there is an increasing demand for rechargeable batteries, e.g., to enable electrification of transportation and to supplement renewable energy. Such batteries typically comprise a number of battery cells coupled together to provide the desired voltage and current.

Rechargeable or “secondary” battery cells find widespread use as electrical power supplies and energy storage systems. For example, in automobiles, battery packs formed of a plurality of battery cells, wherein each battery module includes a plurality of battery cells, are provided as a means of effective storage and utilization of electric power.

Several different form factors exist for battery cells, depending on their intended application field. In automotive applications, some common form factors for battery cells are cylindrical, prismatic and pouch cells.

A battery cell stores electrical energy in an electrode assembly, which may be stacked or rolled, and referred to as an “electrode roll” or a “jelly roll”. Stored electrical energy may then be collected and transferred to the terminals of the battery cell via current collectors, which are adapted for (electrical) connection to the terminal(s) and to the electrode assembly.

During a failure event of a battery cell, gas may be generated through various chemical reactions (depending on the chemistry of the cell), and heat may also be generated, sometimes very rapidly. If a failure event is not suitably contained, it may propagate to nearby battery cells and cause their failures.

### SUMMARY

It is realized as a part of the present disclosure that a risk of propagation of failures among nearby cells is greatly increased by an explosion or rupture of a cell casing. Ruptures of a cell casing can cause an uncontrolled emission of ejecta (such as gas or charged particles) or, in some cases, parts of the cell casing (which may be made of metal such as aluminum) to come free and short-circuit nearby cells.

It is further realized as part of the present disclosure that one of the causes of a case rupture may be a build-up of gas within a cell. That is, during a failure event (such as a thermal runaway or ‘TR’ event), there is a risk for rapid generation of heat. Furthermore, internal components of the cell such as the electrode assembly may generate substantial amounts of gas. If not properly and promptly vented, this gas may cause a pressure build-up inside the casing. The presence of a spacing element between the electrode assembly and a vent in the casing may be particularly problematic in this respect, as the spacing element may obstruct the flow of gas from the electrode assembly to the vent.

If the rapid heat generation occurs while gas is obstructed and therefore collected within the casing, this may lead to the battery cell exploding, destroying the battery cell, due to the rapid expansion of the gas according to thermodynamic laws. An exploding battery cell does not only risk propagating the failure to nearby battery cells, but is also a hazardous event for the surrounding environment.

Therefore, according to an aspect of the present disclosure, there is provided a battery cell with a spacing element, configured to not only provide spacing (and, in some cases, electrical insulation) between internal components of the battery cell, but also to guide a gas flow to escape the casing through vents in the casing, in order to reduce the risk of gas build-up in the casing, and thereby reduce the risk of a rupture or explosion of the battery cell.

In particular, according to an aspect of the present disclosure, there is provided a battery cell comprising an electrode assembly, a vent in a casing of the battery cell, and a spacing element extending along a first side of a cell. The spacing element may be arranged to provide spacing between different internal components of the cell or between internal components of the cell and the casing.

In an embodiment, the spacing element may extend along a portion of the first side of the electrode assembly while, in another embodiment, the spacing element may extend along the entirety of the first side of the electrode assembly. In a preferred embodiment, the battery cell may be a prismatic cell, the vent may be formed in a lid thereof, and the spacing element may be arranged along a longer side of a prismatic cell, between the electrode assembly and the lid.

More generally, in some embodiments, the spacing element may extend along the same side as the placement of the vent in the casing. The spacing element may then be arranged adjacent to the vent in the casing and may be aligned with the vent so as to further enhance the ability of the spacing element to guide gas flow out of the vent. In alternative embodiments, the spacing element may instead or also extend along a different side of the electrode assembly.

In some embodiments, multiple spacing elements may be installed along the side of the electrode assembly. For example, one spacing element may extend from a first end of a first side of the electrode assembly to adjacent a first terminal (or adjacent a first vent), and another spacing element may extend from a second end of the first side of the electrode assembly to adjacent a second terminal (or adjacent a second or the first vent). The spacing elements may be aligned with the terminal(s) and may allow for no obstruction under the vent(s) in the casing.

In an embodiment where the cell is a prismatic cell, the spacing element may have a substantially rectangular shape with a width corresponding to the width of the electrode assembly, or corresponding to the size and shape of the casing. Thus, the spacing element may substantially span a cross-sectional area of the casing to thereby ensure that the electrode assembly is appropriately spaced from the casing. Further, it may be defined that the spacing element has a top side facing the casing, and a bottom side facing the electrode assembly.

Following the example of a prismatic cell having an electrode assembly with a substantially rectangular shape, the spacing element may be arranged (based on the installation position) along a top side, bottom side or one of the opposite sides of the electrode assembly. Further, the spacing element may be arranged along a side of the electrode assembly different from the side where the vent is arranged in the casing.

The spacing element may be most preferably arranged along a side of the electrode assembly where most gas generation is expected. For example, the spacing element may be arranged along a side of the electrode assembly comprising uncoated parts of electrode sheets, e.g., along a side that is parallel to a side of the casing where terminals are arranged.

Since gas generation may occur in more than one place within the casing, there is a risk for the gas to be obstructed if there is no clear and well-defined directional fluid path between the electrode assembly and the vent in the casing. If the generated gas is obstructed, it may not reach the vent and escape the casing. As a result of this, gas may be collected and get stuck within the casing, causing a pressure build-up which, as discussed above, in a worst case could lead to an explosion of the battery cell.

Therefore, according to an advantageous aspect of the present disclosure, the spacing element is advantageously arranged in a fluid path between the electrode assembly and the vent and configured to guide gas flow from the electrode assembly to the vent, such that a gas flow can be guided from the place where it is generated (i.e., the electrode assembly) towards the vent.

Hence, according to this aspect of the present disclosure, a risk of the cell exploding can be greatly reduced. Moreover, a risk of a failure of a cell propagating to other nearby cells can be reduced. Thus, an isolation of the failure event may be achieved.

In an example embodiment, the spacing element may be configured to substantially span a space between the first side of the electrode assembly and the casing. The spacing element may therefore increase the surface area between the first side of the electrode assembly and the casing, thereby increasing the space for the generated gas to be distributed on, and ensuring that the spacing element is in a fluid path of the gas flow from the electrode assembly to the vent.

That is, since the spacing element spans a space between the electrode assembly and the casing, not only are short-circuits advantageously prevented, as discussed above, but also the guiding of the gas flow may be enhanced. Gas in the space which the spacing element spans will be directed by the spacing element to flow in a direction towards the vent. If there is a continuous generation of gas coming from a certain area, the gas may be prevented from flowing back towards where it originated from by dividing an internal space of the cell into a higher pressure section towards the electrode assembly and a lower pressure section towards the vent. Thus, the gas will be advantageously guided in a unidirectional manner by the spacing element towards the vent, the spacing element being configured for such guiding as discussed above.

Additionally, the spacing element may also advantageously provide protection for the electrode assembly from sharp edges etc. formed by a buckling, deformation, or breaking of the casing (e.g., made of metal such as aluminum) during a crush event. Thus, by preventing a sharp piercing damage to the electrode assembly during a crush event, the risk of a catastrophic failure of a cell may be advantageously reduced.

That is, the spacing element may more readily resist the impact force of the crush event by presenting an effective ‘crumple zone’ between the casing and the electrode assembly such that the impact force of the crush event may cause a deformation and/or displacement of the spacing element rather than causing damage to the electrode assembly.

Further, through-holes may provide a fluid path through the spacing element, and one or more channels may provide a way for guiding the gas through the spacing element towards the vent. The spacing element may comprise a plurality of through-holes/channels distributed over the entire surface of the spacing element, or focused in localized portions of expected (increased) incident gas flow.

For example, a plurality of through-holes may enable a greater gas flow towards the vent, and thereby prevent an increase of internal pressure due to gas build-up inside the casing. Furthermore, the through-holes in the spacing element may allow the gas to flow from one side of the spacing element to another. For example, if gas is generated and on a side of the electrode assembly, and flows up towards the ‘bottom’ side of the spacing element (as defined above), the through-holes may allow the gas to travel through the spacing element and come out on the ‘top’ side of the spacing element, and vice versa. Hence, an obstruction of gas flow from multiple directions relative to the spacing element may be advantageously reduced, and versatile mounting options for the spacing element are allowed for.

The presence of through-holes may also advantageously decrease the amount of material needed to create the spacing element, and reduce the overall weight of the spacing element and thus any cell into which the spacing element is installed.

In another example, the spacing element may comprise one or more channels configured to guide gas flow along the fluid path.

The channels may enable guiding of the gas flow towards the vent. The channels may for example be cavities, recesses, and may be straight, curved, or take any suitable form depending on the desired gas flow. The channels may create a space for gas to enter and flow through. Generated gas filling up the space inside the casing may thus be channeled by the channels towards the vent in the casing, such that the gas is guided to the vent and a build-up of gas within the cell is reduced.

The channels may extend along a portion of the length and/or width of the spacing element, or extend along the entirety of the length and/or width of the spacing element. In some examples, there may be a plurality of channels distributed on the spacing element. A plurality of channels may enable for a greater gas flow towards the vent, and may thereby decrease the build-up of gas inside the casing. Furthermore, a channel shaped as a recess may create a distinct fluid path for the gas flow to follow, facilitating the escape of the gas, without forming an enclosed space which could be blocked or otherwise obstructed.

In a preferred embodiment, the spacing element comprises one or more through-holes and one or more channels. This may be preferred because the spacing element both actively guides the gas flow towards the vent (i.e., using the channels), and allows gas to flow through the spacing element (i.e., through through-holes)—for example, for fluid paths that would benefit less from such guiding—and thus the spacing element may let the gas flow from throughout an internal space of the cell escape the casing, increasing the efficiency of the spacing element in performing its (additional) function as a guide for gas flow. ‘Active’ guiding as referred to herein may comprise changing a direction of gas flow.

In some example embodiments, there is more than one vent in the casing. For example, there may be two or three vents placed in the casing. In one embodiment, these vents may be arranged on the same side of the casing. In another embodiment, the vents may be arranged on different sides of the casing. In such embodiments, there may be more than one spacing element installed in the battery cell, each spacing element being configured to guide gas flow towards a respective vent or towards multiple vents.

As mentioned above, the casing may comprise a lid, in which the vents may be formed. The lid may, for example, be arranged in the top of the casing, thus the top of the battery cell (based on the installation position). Since the lid may be a separate manufacturing component during the manufacture of the battery cell, the configuration thereof may be interchanged if there is, for example, a need to adapt the number and/or placement of the vent(s). That is, the entire battery cell manufacturing process may not need to be modified, as the lid may simply be switched to another adapted lid or modified to meet the requirements.

The battery cell may further comprise a current collector connecting the electrode assembly and a terminal of the battery cell. For example, the current collector may attach to the electrode assembly along a first side thereof, and attach to the terminal along a second side of the electrode assembly adjacent to the first side. In another example, the current collector may attach to the electrode assembly and the terminal along the first side of the electrode assembly, which may be the same side along which the spacing element extends/is arranged.

That is, at least a portion of the spacing element may advantageously be arranged between the current collector and the casing. Thus, the spacing element may be configured to provide electrical insulation between the current collector and the casing (which may be made of metal such as aluminum). During a crush event, for example, the spacing element may act as a protective layer between the current collector and the casing, preventing the same from coming into contact, causing a short-circuit.

According to an example embodiment, the spacing element may comprise one or more mating elements configured to mate with corresponding mating elements on the current collector, such that the spacing element retains the current collector. The mating elements may for example be protrusions, channels or legs.

Therefore, the motion of the current collector during a crush event may be better controlled through engagement with the spacing element, and thus a displacement of the current collector towards the casing during a crush event may be reduced. Moreover, the displacement of the current collector when the cell is subject to less severe motions such as a vibration or acceleration, which may be anticipated if the cell is installed into a vehicle, may also be reduced.

Thus, when a crush event occurs, it can be expected that the current collector will be in its correct position in the cell (i.e., the same position as that into which it was installed), and not in a different position which may pose a greater risk to the electrode assembly during a crush event.

Further, the spacing element may comprise one or more mating elements configured to mate with corresponding mating elements on the electrode assembly and/or a casing, to thereby retain the spacing element in position in the battery cell.

That is, the same effect as for the current collector applies to the spacing element. When the spacing element and the electrode assembly and/or casing are mated, the motion of the spacing element during a crush event or less severe motions may also be better controlled, such that the gas flow guiding abilities of the spacing element (e.g., facilitated by an alignment with the vent) are maintained. Thus, the risk for a pressure build-up due to trapped gas is further decreased, since it can be expected that the spacing element is resiliently held in its installed position.

According to another aspect of the present disclosure, there is provided a spacing element adapted for use in a battery cell substantially as described above.

Moreover, according to yet a further aspect of the present disclosure, there is provided a method for manufacturing a battery cell substantially as described above. The method may comprise arranging the spacing element in the battery cell, along the first side of the electrode assembly, in a fluid path between the electrode assembly and the vent, such that the spacing element may guide gas flow along the fluid path from the electrode assembly to the vent(s).

That is, the method may comprise arranging the spacing element along the first side of the electrode assembly. The arranging of the spacing element may be performed by any manual or automatic means, and may form part of a wider cell assembly process. The relative arrangement of the spacing element, the current collector, electrode assembly and casing may be in any order. For example, the electrode assembly may be arranged in the casing before the current collector and the spacing element are introduced, the electrode assembly, current collector, and spacing element may be arranged relative to each other before their collective introduction into the casing, etc.

In any event, numerous advantages, some of which are described above, may be realized through a specially adapted shape of a spacing element in a battery cell. These advantages, as well as others, may be further appreciated through a description of specific illustrated embodiments.

### BRIEF DESCRIPTION OF THE DRAWINGS

One or more embodiments will be described, by way of example only, and with reference to the following figures, in which:

FIGS. 1a and 1b schematically show a side view and a top view, respectively, of a prismatic cell as an example of a battery cell;

FIGS. 2a and 2b schematically show a partial cross-sectional view of a battery cell with a spacing element, during a failure event resulting in an explosion, according to a comparative example against which the present embodiments can be compared;

FIG. 3 schematically shows a cross-sectional view of a battery cell having an improved spacing element according to an embodiment of the present disclosure;

FIG. 4 schematically shows a cross-sectional view of the battery cell shown in FIG. 3, having generated gas;

FIGS. 5a and 5b schematically show a mating of a current collector with a spacing element according to an embodiment of the present disclosure;

FIGS. 6a to 6e show various views of a spacing element according to an example embodiment of the present disclosure;

FIG. 7 illustrates a method of manufacturing a battery cell according to an embodiment of the present disclosure.

### DETAILED DESCRIPTION

The present disclosure is described in the following by way of a number of illustrative examples. It will be appreciated that these examples are provided for illustration and explanation only and are not intended to be limiting on the scope of the disclosure.

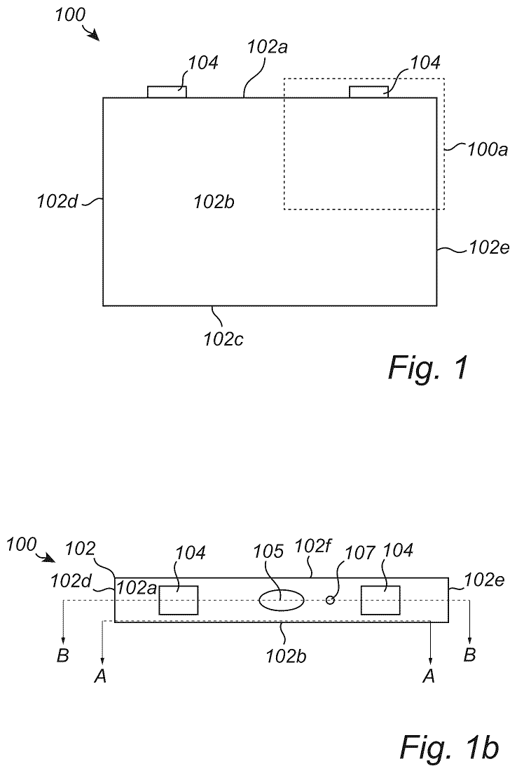

FIGS. 1a and 1b schematically shows a battery cell 100, also referred to hereinafter as “cell 100”, having a prismatic form factor. The cell 100 may have a substantially cuboidal shape, thereby having a rectangular profile, as shown in FIG. 1a.

The cell 100 may comprise a casing 102, which may determine the general form factor of the cell 100 and may be configured (e.g., in its dimensions) for installation into a larger battery module, battery pack, or other external shocks or impacts, for example being made of metal such as aluminum, or made of a high-density plastic.

The casing 102 may be formed from a plurality of sides joined together or may be formed of substantially one or two pieces, e.g., by extrusion, additive manufacturing (AM), or some other manufacturing technique. According to an example, the casing 102 may comprise a height (extending vertically as shown in FIG. 1), a width (extending horizontally as shown in FIG. 1), and a thickness (not visible).

The prismatic form factor for the cell 100, as defined substantially by the casing 102, may comprise two larger faces 102b, 102f spaced apart by a relatively small distance in the thickness direction, and a plurality of comparatively smaller faces 102a, 102c, 102d, 102e bridging between the two larger faces 102b. The casing 102 may be formed by providing an open cuboidal shape, and sealing the open face of the open cuboidal shape with a lid. For example, the lid may form the upper face 102a of the casing 102 (shown in more detail in FIG. 1b).

Internal components of the cell 100 may be introduced into the casing 102 and then a lid 102a may be provided thereover and sealed in placed to thereby contain the internal components. The lid 102a may be attached in a substantially watertight fashion so as to contain liquid electrolyte in the cell 100, for example. The lid 102a may be provided with a failure vent 105 (or simply ‘vent 105’), an injection port 107 for injecting electrolyte, and/or other features, the details of which are outside the scope of the present disclosure.

In the illustrated example, provided on the casing 102 of the cell, and extending therethrough to an internal space of the cell 100, are a pair of terminals 104. One of the terminals 104 may be a negative electrode (e.g., an anode) and the other may be a positive electrode (e.g., a cathode). The terminals 104 may be riveted through the casing 102, e.g., through the lid 102a thereof, and provided with a gasket therearound to improve the watertight seal that the casing 102 may preferably provide. The terminals 104 may be made of any suitable conductive material, although the particular manufacture and installation of the terminals 104 is outside the scope of the present disclosure.

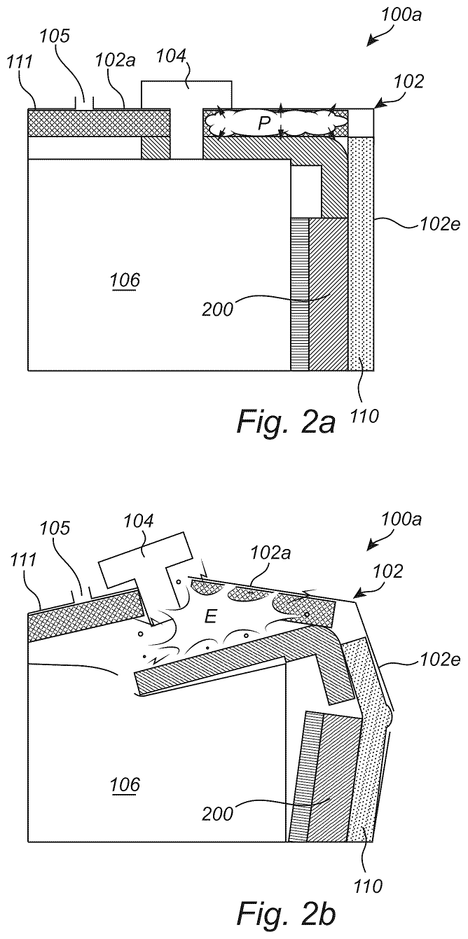

Both of the terminals 104 are shown installed at an upper face 102a of the casing 102 of the cell 100. However, it will be appreciated that either of the terminals 104 may instead be provided at any location around the casing 102 of the cell 100. FIGS. 2a and 2b schematically show a partial cross-sectional view of a battery cell 100 with a spacing element 110, during a failure event resulting in an explosion, according to a comparative example against which the present embodiments can be compared. Any reference to prior art documents or comparative examples in this specification is not to be considered an admission that such prior art is widely known or forms part of the common general knowledge in the field.

The cross-section shown in FIGS. 2a and 2b correspond to the portion 100a indicated by the dotted box in FIG. 1a and the cross-section is taken along the line A-A as shown in FIG. 1b.

According to this comparative example, the spacing element 110 may be arranged to provide spacing between internal components of the battery cell 100. In the illustrated example, the spacing element 110 is arranged between upper face 102a (as illustrated) of the casing 102 (which may be the lid) and the electrode assembly 106 so as to provide appropriate spacing therebetween.

In this example, the terminal 104 extends through the spacing element 110 and connects to the current collector 200 so as to form a current path between the terminal 104 and the electrode assembly 106. By maintaining an appropriate spacing between the terminal 104, the casing 102, the electrode assembly 106, and the current collector 200, these components may be advantageously prevented from being displaced or coming into contact with each other, which may cause a short-circuit.

During normal operation or during a failure (e.g., in the initial stages thereof), the electrode assembly 106 may generate gas as a result of being heated, or one or more chemical reactions, the specifics of which are outside the scope of the present disclosure. As shown in FIG. 2a, this gas may collect in the cell 100 and may cause a build-up P. In some cases, this build-up P may have an increased pressure relative to the ambient operational pressure of the cell 100.

According to this comparative example, the spacing element 110 blocks (or otherwise obstructs) a passage of generated gas and therefore contributes to the build-up P in the corner of the cell 100 as illustrated. Thus, when the cell 100 accelerates in its heating due to, e.g., a TR event, the build-up P of gas is (super-)heated and therefore it will be appreciated that the gas rapidly expands, according to thermodynamic principles. As shown in FIG. 2b, this rapid expansion can lead to an explosion E of the cell 100.

During the explosion E of the cell 100, the casing 102 may be ruptured and/or fragmented, causing pieces thereof to be propelled from the explosion E. The casing 102 may be made of metal such as aluminum and, thus, if a piece of the casing 102 were to contact across the terminals of a nearby cell, a short-circuit of said cell could be caused, which could trigger the subsequent failure of said cell and thus propagate the failure event.

Therefore, aspects of the present disclosure are directed toward preventing a build up of gas within a cell, as it is realized as a part of the present disclosure that this can reduce damage to a cell during a failure event and the risk of the failure event propagating to nearby cells.

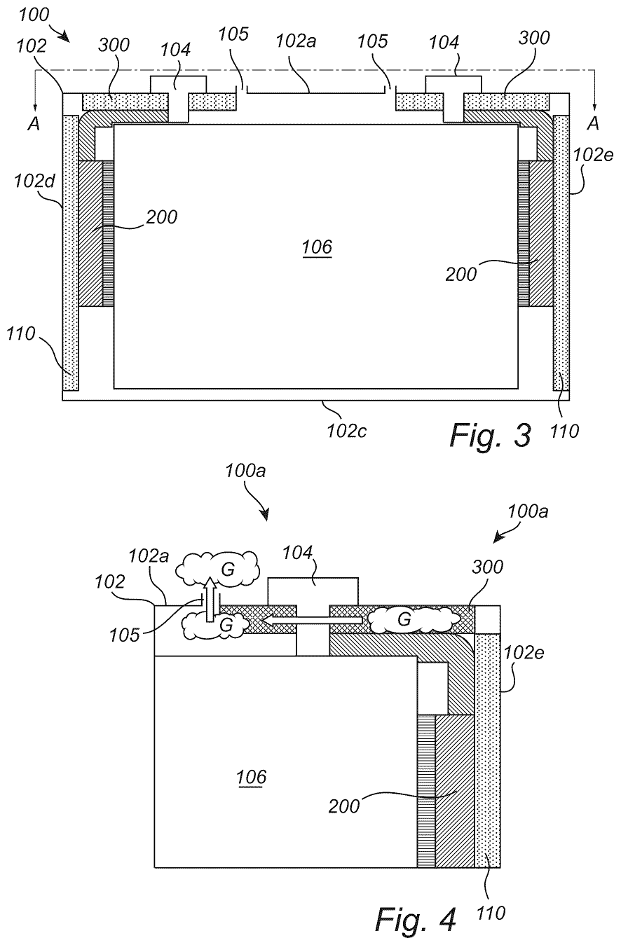

FIG. 3 schematically shows a cross-sectional view of a battery cell 100 comprising a spacing element 300 according to an embodiment of the present disclosure, wherein the spacing element 300 is configured to guide gas flow from the electrode assembly 106 to a vent 103 in the casing 102.

Like-numbered components of the cell 100 may be the same as those described above in relation to FIGS. 1, 2a, and 2b, or at least substantially similar in their function so as not to warrant further discussion.

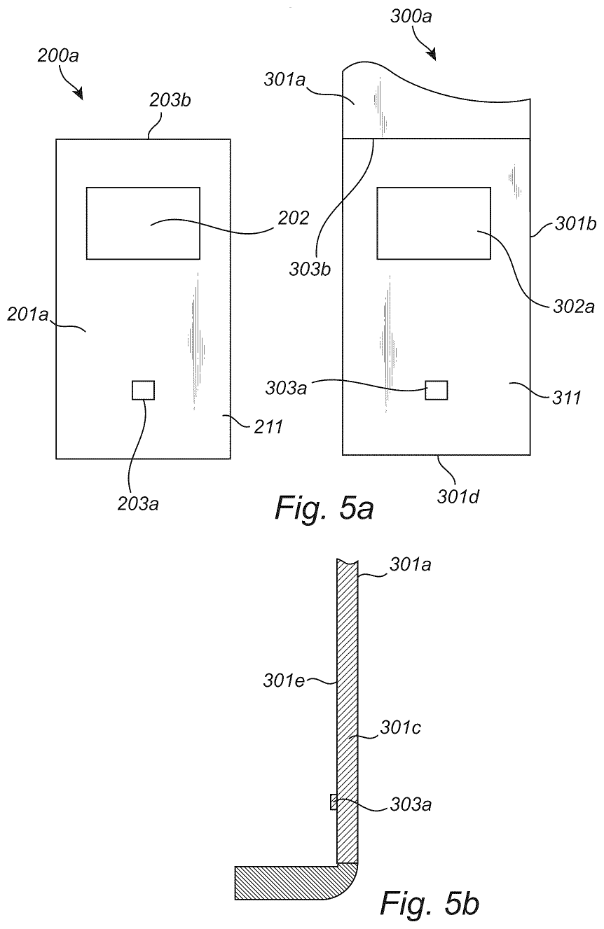

FIG. 4 shows the battery cell 100 of FIG. 3, having the improved spacing element 300, showing a gas flow G through the cell 100. As for FIGS. 2a and 2b, FIG. 4 corresponds to the portion 100a indicated by the dotted box in FIG. 1a and the cross-section is taken along the line A-A as shown in FIG. 1b.

The spacing element 300 contained in the example embodiment shown in FIGS. 3 and 4 is arranged in a fluid path between the electrode assembly 106 and the vent 105, and is configured to guide gas flow G by, for example, comprising one or more through-holes and/or one or more channels. The right side of the electrode assembly 106 (as illustrated) may generate gas G which is incident upon the spacing element 300, shown in a fluid path between the electrode assembly 106 and the vent 105.

In particular, in this illustrated example, a fluid path is present along the right side (as illustrated) of the electrode assembly (e.g., around the current collector 200) and along the upper side of the cell 100, i.e., bounded by the lid 102a. The spacing element 300 is then arranged in this fluid path such that the flow of gas G can be guided, e.g., steered, around the corner of the cell 100 and toward the vent 105. The gas G may be guided by, for example, one or more channels formed in and/or on the spacing element 300

It will be appreciated that a fluid path also exists between the upper side (as illustrated) of the electrode assembly 106 and the vent 105. If the spacing element 300 were arranged in this fluid path, gas G may be permitted therethrough and out of the vent 105 through the provision of one or more through-holes.

The illustrated spacing element 300 also guides gas flow G around the terminal 104 of the cell, and may comprise a through-hole to permit passage of the terminal 104 therethrough. The spacing element 300 may be further configured to mate or otherwise engage with the current collector 200 and/or electrode assembly 106, depending on the implementation.

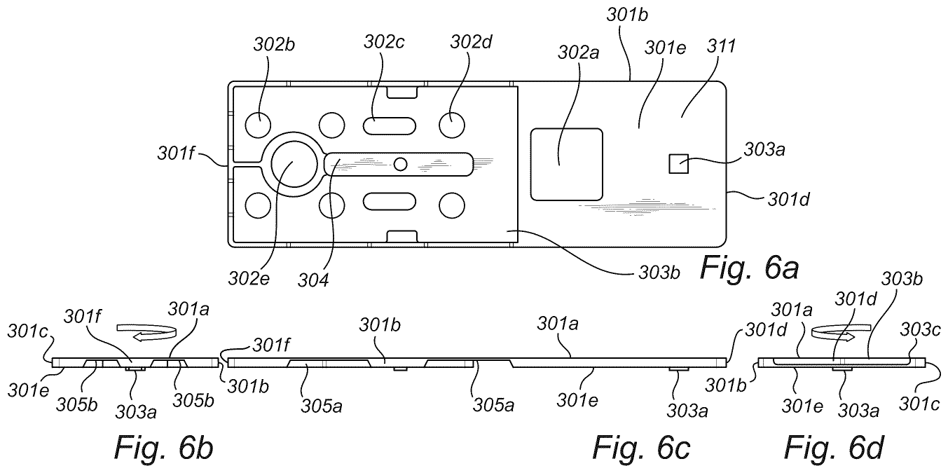

FIGS. 5a and 5b schematically show a respective configuration of the current collector 200 and the spacing element 300 to enable a mating of these components, according to an example embodiment of the present disclosure.

FIG. 5a shows a front-on view and FIG. 5b shows a side view of the current collector 200 and the spacing element 300 in a mated configuration. As shown in these figures, the spacing element 300 may comprise a main body 311 on which one or more mating elements are arranged. Similarly, the current collector 200 may comprise a main body 211 on which corresponding mating elements are arranged. The mating elements in the illustrated example comprise a protrusion 203a on the current collector 200, protruding from the main body 211 thereof, and a corresponding hole 303a recessed from the main body 311 of the spacing element 300.

The specific configuration and manufacture of the current collector 200 is outside the scope of the present disclosure. However, according to the illustrated example the current collector 200 comprises a section 200a for connecting to a terminal of a cell (i.e., internally, via some riveting connection or otherwise). The section 200a may comprise a through-hole 202 for receiving a terminal of a cell. Furthermore, the current collector 200 in the illustrated example comprises a bottom side 201a (i.e., for facing the electrode assembly when arranged in the cell) from where a protrusion 203a protrudes, acting as a mating element for mating with the spacing element 300.

The first section 200a further comprises an end portion 203b, configured to mate with a receiving portion 303b on the section 300a of the spacing element 300. That is, the receiving portion 303b may have a complementary shaping to the end portion 203b of the current collector 200 such that, when mated, the current collector 200 and the spacing element 300 may form a substantially flush profile, as shown in FIG. 5b.

The section 300a of the spacing element 300 comprises a top side 301a, a first side 301b, a second side 301c, and a third side 301d, as illustrated in FIG. 5a. It will be appreciated from the illustrated example that a surface of the top side 301a delimited by the receiving portion 303b, the first side 301b, the second side 301c and the third side 301d may be recessed from the main body 311 of the spacing element 300, and thus have a thickness less than a thickness of the remainder of the spacing element 300.

The spacing element 300 further comprises a through-hole 302a configured to be aligned with the through-hole 202 of the current collector 200. Thus, the terminal 104 of a cell 100 may be received in the aligned through-holes 202 and 302a. The current collector 200 may thus connect to the terminal 104 when mated with the spacing element 300, without having to modify any of the parts. Furthermore, the terminal 104 may provide additional stability to the current collector 200 and the spacing element 300, by preventing them from moving out from their installed positions.

The section 300a of the spacing element 300 further comprises a hole 303a recessed from the top side 301a of the spacing element 300. The hole 303a is configured to mate with the protrusion 203a of the current collector 200. That is, in the illustrative example, through-holes 202 and 302, together with the end portion 203b and the receiving portion 303b, and the protrusion 203a and the hole 303a are all examples of mating elements of the current collector 200 and the spacing element 300.

FIG. 5b shows the section 200a mated with the section 300a, by which the current collector 200 is mated with the spacing element 300. It can be seen therein that the thickness of the section 200a may correspond to a thickness of the section 300a, such that the current collector 200 together with the spacing element 300 can span a space between an electrode assembly 106 and a casing 102 of the battery cell 100 (not shown in this figure) in the region of the current collector 200 when installed in the battery cell 100.

It can be seen that the hole 303a may extend from the side 301a, through the thickness of the spacing element 300 and protrude from the opposite side, side 301e of the spacing element, as seen in FIG. 5b. Further, the spacing element 300 comprises a bottom side 301e, for facing the electrode assembly when installed in a battery cell.

It will be appreciated from the illustrated example that the first and second sides 301b, 301c may comprise peripheral ridges corresponding to the thickness of the spacing element 300, and placed along a length of the recessed surface delimited by the receiving portion 303b, the first and second sides 301b, 301c and the third side 301d. That is, the peripheral ridge of the second side 301c is covering a side of the current collector 200 in the mated position shown in FIG. 5b.

The peripheral ridges may further hold the current collector 200 in place when mated with the spacing element 300 and may thus prevent the current collector 200 from moving out from its installed position. Thereby, by mating the current collector 200 with the spacing element 300 may increase a robustness of the battery cell 100.

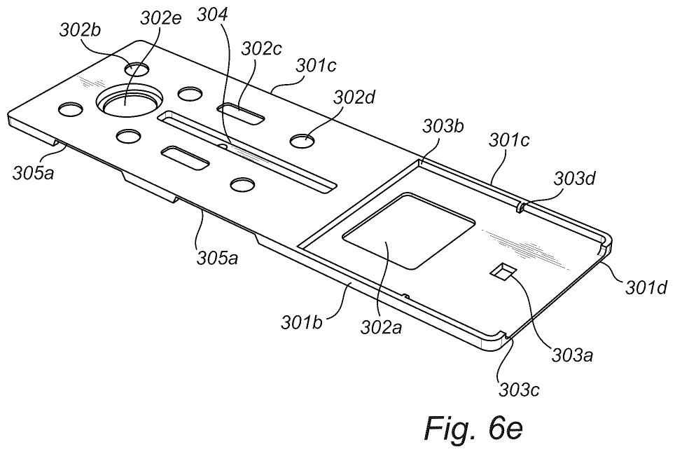

FIGS. 6a to 6e show various views of an example implementation of the presently disclosed spacing element 300, configured for installation into a prismatic cell having a rectangular profile. FIG. 6a shows a bottom view of the spacing element, wherein a “bottom” view of the spacing element 300 may be defined as that intended for facing the electrode assembly 106 when arranged in a cell. FIGS. 6b to 6d show a front view, side view and rear view, respectively, wherein a “side” view of the spacing element 300 may be defined as parallel to a short side of a prismatic cell. The “front” and “rear” view may be defined as being parallel to a long side of the prismatic cell, in the illustrative example where the spacing element 300 is substantially rectangular to correspond to the form factor of the cell. FIG. 6e shows a perspective view of the spacing element 300.

The illustrated spacing element 300 may be made from any suitable material, such as an electrically insulating material. The spacing element 300 may preferably be formed from a material with good structural properties that can be readily shaped with high accuracy. For example, the spacing element 300 may be made of a plastic and/or formed using injection molding, extrusion molding, or the like. A sheet of plastic may be provided which is then shaped and cut using one or more processing steps to provide the various features of the spacing element described herein. The particulars of such processing steps are outside the scope of the present disclosure.

As shown in FIGS. 6a to 6e, the spacing element 300 comprises a main body 311 which is substantially flat. The main body 311 may substantially define the overall dimensions of the spacing element 300. In the illustrated example, the spacing element 300 has a substantially rectangular outer shape, which may be dimensioned to correspond to a shape and size of a first side of an electrode assembly and/or a casing of a cell, along which the spacing element 300 may be arranged. Thus, the spacing element 300 may be retained in position by having a shape corresponding to that of a first side of the electrode assembly.

FIG. 6a shows various types and placements of through-holes for permitting gas flow through the spacing element 300. The through-holes may have different sizes, placements and shapes. In the illustrative example, there are five types of through-holes, which are being grouped by the same reference number. The through-hole 302e has a substantially circular shape, and may be positioned so as to align with a vent in a casing, when installed in a cell. That is, the vent and the through-hole 302e may be aligned such that a fluid path is created between the vent and the electrode assembly, via the spacing element 300. This may further enhance the ability of the spacing element 300 to guide gas flow out of the vent.

The through-holes 302b, 302c and 302d are distributed over the surface of the spacing element that is delimited by the receiving portion 303b, and the sides 301b, 301c and 301f. That is, the through-holes 302b, 302c and 302d are distributed over the surface that is not specifically configured for mating with the current collector 200. The more through-holes arranged in the spacing element 300, the more gas is permitted to flow through, and the amount of material needed to create the spacing element is advantageously decreased.

The spacing element 300 further comprises a channel 304, protruding from the main body 311 of the spacing element 300. The protrusion of the channel 304 from the bottom side 301e of the spacing element 300, forms a recessed channel 304 seen from the top side 301a of the spacing element 300, as seen in FIG. 6e. The channel 304 extends on the surface delimited by the receiving portion 303b, and the sides 301b, 301c and 301f. That is, the channel 304 extends on the surface that is not specifically configured for mating with the current collector 200.

Further, the same delimited surface in its entirety may be recessed from the main body 311 of the spacing element 300, such that the surface itself acts as a channel for guiding gas flow towards the vent 105 in the casing 102 of the cell 100. In the illustrative example as seen in FIG. 6a the channel 304 coincides with the though-hole 302e, such that gas that is in the channel 104 can advantageously be led directly from the channel 104 out through the through-hole 302e and out through the vent of the cell (not shown in this figure). As previously discussed, the spacing element 300 further comprises a through-hole 302a and a hole 303a for mating with the current collector 200.

FIGS. 6b to 6d shows various types and placements of channels for permitting and guiding gas flow through the spacing element 300. The channels may have different sizes, placements and shapes. FIG. 6b illustrates a front view of the spacing element 300. The side 301f comprises channels 305b. The channels 305b are extending along the length of the side 301f, and along a portion of the width of the spacing element 300. That is, a gas flow coming from a side of a casing and flowing towards the side 301f of the spacing element 300, may flow through the channels 305b to the inside of the spacing element 300, and then further through one of the through-holes 302b, 302c, 302d or 302e and out towards a vent in the casing.

FIG. 6c illustrates a side view of the spacing element 300. The side 301b comprises channels 305a. The channels 305a are extending along the length of the side 301f, and along a portion of the width of the spacing element 300. That is, a gas flow coming from a side of a casing and flowing towards the side 301b of the spacing element 300, may flow through the channels 305a to the inside of the spacing element 300, and then further through one of the through-holes 302b, 302c, 302d, 302e or the channel 304 and out towards a vent in the casing. The spacing element 300 thus efficiently guides gas towards the vent(s) regardless of the direction the gas is flowing from.

FIG. 6d illustrates a rear view and a side 301d of the spacing element 300. From this view, the recessed surface for mating with the current collector is shown, as well as the peripheral ridges on the sides 301b and 301c as previously discussed in FIGS. 5a to 5b.

The spacing element further comprises protrusions 303d, protruding from the peripheral ridges of the sides 301b and 301c, as seen in FIG. 6e. The protrusions 303d further acts as mating elements for mating the spacing element 300 with a current collector. In an illustrative example, the side 301d further comprises side portions 303c, protruding from the main body 311. The side portions 303c may be arranged to mate with a current collector.

It will be appreciated that the example implementation of a spacing element described in respect of FIGS. 6a to 6e is but one example of many which may fall within the scope of the present disclosure, and this illustrated example has been provided merely to assist in understanding particular aspects of the present disclosure.

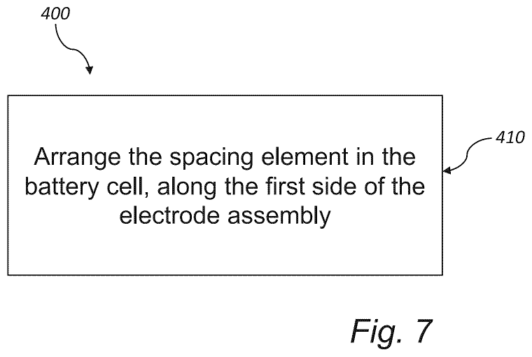

FIG. 7 illustrates a method 400 for manufacturing a battery cell such as the battery assembly 100 discussed above, having an spacing element such as the insulating element 300 described above.

The method may comprise a step 410 of arranging the spacing element in the battery cell, along the first side of the electrode assembly. This arranging may be performed manually or automatically, e.g., under the action of one or more automated manipulators, which may form part of a wider manual or (partially) automated battery assembly process.

The spacing element may be arranged in the battery cell along the first side of the electrode assembly such that a through-hole or channel is aligned with a vent in the casing. In any event, a battery cell being advantageously configured for releasing gas and isolating failure events, as discussed above, may be provided by the performance of such a method 400.

While the present disclosure is susceptible to various modifications and alternative forms, specific embodiments are shown and described by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

Nonetheless, the present disclosure may be better understood through the following numbered embodiments:

1. A battery cell, comprising:
an electrode assembly; and
a vent in a casing of the battery cell; and
a spacing element extending along a first side of the electrode assembly and arranged in a fluid path between the electrode assembly and the vent, wherein:
   the spacing element is configured to guide gas flow along the fluid path from the electrode assembly to the vent.

2. The battery cell according to embodiment 1, wherein the spacing element comprises one or more through-holes configured to permit gas flow along the fluid path.

3. The battery cell according to embodiment 1 or 2, wherein the spacing element comprises one or more channels configured to guide gas flow along the fluid path.

4. The battery cell according to any preceding embodiment, wherein the spacing element is configured to substantially span a space between the electrode assembly and the casing.

5. The battery cell according to any preceding embodiment, wherein the casing comprises a lid, and the vent is arranged in the lid of the casing.

6. The battery cell according to any preceding embodiment, further comprising a current collector connecting the electrode assembly and a terminal of the battery cell, wherein at least a portion of the spacing element is arranged between the current collector and the casing.

7. The battery cell according to any preceding embodiment, wherein the spacing element is configured to retain the current collector.

8. The battery cell according to embodiment 7, wherein the spacing element comprises one or more mating elements configured to mate with corresponding mating elements on the current collector to thereby retain the current collector.

9. The battery cell according to any preceding embodiment, wherein the spacing element comprises one or more mating elements configured to mate with corresponding mating elements on the electrode assembly and/or a casing, to thereby retain the spacing element in position in the battery cell.

10. A spacing element adapted for use in a battery cell according to any preceding embodiment.

11. A method for manufacturing a battery cell according to any preceding embodiment, comprising:
arranging the spacing element in the battery cell, along the first side of the electrode assembly, in a fluid path between the electrode assembly and the vent.

1. A battery cell, comprising:
an electrode assembly;
a vent in a casing of the battery cell; and
a spacing element extending along a first side of the electrode assembly and arranged in a fluid path between the electrode assembly and the vent,
wherein:
the spacing element comprises one or more channels configured to guide gas flow along the fluid path from the electrode assembly to the vent, and
at least one of said one or more channels is shaped as a recess.

2. The battery cell according to claim 1, wherein the spacing element comprises one or more through-holes configured to permit gas flow along the fluid path.

3. The battery cell according to claim 1, wherein the spacing element is configured to substantially span a space between the electrode assembly and the casing.

4. The battery cell according to claim 1, wherein the casing comprises a lid, and the vent is arranged in the lid of the casing.

5. The battery cell according to claim 1, further comprising a current collector connecting the electrode assembly and a terminal of the battery cell, wherein at least a portion of the spacing element is arranged between the current collector and the casing.

6. The battery cell according to claim 5, wherein the spacing element is configured to retain the current collector.

7. The battery cell according to claim 6, wherein the spacing element comprises one or more mating elements configured to mate with corresponding mating elements on the current collector to thereby retain the current collector.

8. The battery cell according to claim 1, wherein the spacing element comprises one or more mating elements configured to mate with corresponding mating elements on the electrode assembly and/or a casing, to thereby retain the spacing element in position in the battery cell.

9. A spacing element adapted for use in a battery cell according to claim 1.

10. A method for manufacturing the battery cell according to claim 1, the method comprising:
arranging the spacing element in the battery cell, along the first side of the electrode assembly, in a fluid path between the electrode assembly and the vent.
